(19) United States
(12) Patent Application Publication
(10) Pub. No.: US 2011/0315883 A1
(43) Pub. Date: Dec. 29, 2011

(54) THIN FILM MEASUREMENT TECHNIQUE

(75) Inventor: Soren Harrison, Somerville, MA (US)

(73) Assignee: Fusion Research Technologies, LLC, Somerville, MA (US)

(21) Appl. No.: 13/123,143

(22) PCT Filed: Oct. 8, 2009
(86) PCT No.: PCT/US09/59989

§ 371 Date: Sep. 6, 2011

Related U.S. Application Data
(60) Provisional application No. 61/195,520, filed on Oct. 8, 2008.

(51) Int. Cl. G01N 23/08; G01N 23/083; G21F 3/00

(52) U.S. Cl. 250/358.1; 250/506.1

(57) ABSTRACT

A thin film measurement technique is disclosed. The thin film measurement technique comprises radioisotopes, radiation detectors, mechanical hardware, electronics and/or circuitry, wires, cables, connectors, measurement software, and a computer. One aspect of the thin film measurement technique pertains to measurement sensors, which measure radiation emerging from material surfaces. Another aspect of the disclosure pertains to mechanical hardware that enables the thin film measurement to be made. Another aspect of the disclosure pertains to filter housings. Another aspect of the disclosure pertains to measurement software, for quantifying the measurement from the sensor, and/or controlling and optimizing processes based on said measurements. Another aspect of the disclosure pertains to hardware and equipment utilizing the thin film measurement technique. All aspects can be utilized alone or in combination with one another.

### CROSS-REFERENCE TO RELATED APPLICATION

This patent application claims priority to U.S. Provisional Application Ser. No. 61/195,520 filed in the U.S. Patent and Trademark Office on Oct. 8, 2008, the entire contents of which is incorporated herein by reference in its entirety.

### STATEMENT REGARDING FEDERALLY SPONSORED RESEARCH OR DEVELOPMENT

This invention was made with Government support under Grant No. DE-FG02-07ER86310 awarded by the Department of Energy. The Government has certain rights in this invention.

### BACKGROUND OF THE INVENTION

1. Field of the Invention

The present invention relates to metrology, manufacturing process control, and manufacturing process optimization. More specifically, the present invention relates to the measurement of thin film properties and characteristics; using charged particle spectroscopy and other radiation spectroscopy.

2. Description of the Related Art

There are many techniques currently available to perform surface analysis and characterize thin films. Optical, mechanical, spectroscopic, and capacitive techniques are all used for a wide variety of applications to measure properties of material surfaces. Each of the different measurement techniques is limited in its application to measure material properties and characteristics. Additionally, ion beam accelerators are used to probe material surfaces. A variety of surface analysis techniques exist that rely on the acceleration of ion beams, which then impinge on material surfaces, and cause various particles and radiation to emerge from the material. These particles and radiation can be measured to determine properties and characteristics for material surfaces (e.g. thin films). Ion beam analysis (IBA), as this family of surface analysis techniques is called, requires large and expensive accelerator facilities to perform surface analysis. What is needed then is a surface analysis and thin film measurement technique that can be performed in a small physical footprint, does not require an extensive accelerator facility, and measures properties and characteristics of material surfaces and thin films; one possible embodiment of such a thin film measurement technique integrates a radioisotope, radiation detector, measurement software, mechanical hardware, and ancillary hardware, electronics, and computer components. The present invention fulfills this need.

### BRIEF SUMMARY OF THE INVENTION

Broadly speaking, the present invention relates to metrology, manufacturing process control, and manufacturing process optimization. More specifically, the present invention relates to the measurement of thin film properties and characteristics, using charged particle spectroscopy and other radiation spectroscopy, with enabling mechanical hardware. The invention can be implemented in numerous ways. Radioisotopes, radiation detectors, measurement software, electronics, hardware, and computer components can be, alone or in any combination, used as a stand-alone measurement system, or integrated into or attached to manufacturing hardware and machines, including but not limited to, vacuum chambers, deposition chambers, plasma chambers, sputtering chambers, load locks, and other hardware for manufacturing thin films.

By way of example, one embodiment of the present invention comprises an alpha radioisotope and charged particle detector integrated together as a measurement sensor; electronics, wires, and cables connecting the measurement sensor and a computer for data acquisition; measurement software for quantifying the measurement performing analysis, optimizing and controlling manufacturing processes; and enabling hardware for position material samples and/or measurement sensors; all of which are integrated into a vacuum chamber.

These and various other aspects and advantages that characterize the present invention will become apparent from the following detailed description taken in conjunction with the accompanying drawings which, by way of example, illustrate the principles of the invention.

### BRIEF DESCRIPTION OF THE SEVERAL VIEWS OF THE DRAWING

FIG. 1—One example of a conceptual setup of the thin film measurement technique with radioisotope and radiation detector positioned over the material surface of interest.

FIG. 2—One example of the mechanical assembly that positions material samples and/or sensors for measurement by utilizing a rack and pinion, one way needle bearing, and multiple linear bearings to achieve a motion that rotates the four-sided sample/sensor assembly ninety degrees with each linear translation. A translation of the mechanical assembly down and back up constitutes one cycle during which the sample/sensor assembly rotates through a total of ninety degrees.

FIG. 3—The measurement technique can be applied above the mechanical assembly.

FIG. 4—Another possible embodiment of the measurement technique positions the detector and radioisotope below and/or within the mechanical assembly.

FIG. 5—An integrated measurement sensor may include the radioisotope, radiation detector, electronics and circuitry, amplifiers, multi-channel analyzer, and input/output connector. This embodiment of the present invention shows an annual detector with a radioisotope positioned at its axis, as shown in view A-A.

FIG. 6—An isometric view of the integrated measurement sensor.

FIG. 7—The measurement technique is comprised of the measurement sensor (radioisotope and detector), electronics and/or circuitry, a pre-amplifier, an amplifier, a multi-channel analyzer (MCA), and measurement software. A bias voltage may applied to the detector for the measurement to be made. Radiation creates an electrical signal in the measurement sensor, which is passed from each component to the next.

FIG. 8—The thin film measurement technique can be integrated into chambers, equipment, and processes to make in-situ measurements of thin film properties and characteristics. Using a computer, network, and software with the thin film measurement technique allows control and optimization of the processes inside the chamber and/or equipment.

FIG. 9—This embodiment of the filter housing seals radioisotopes, preventing radioactive materials from leaving the container, yet allowing the radiation to escape. This design utilizes porous metal construction, a thin foil, and ultra-high vacuum (UHV) compatible materials.

### DETAILED DESCRIPTION OF THE INVENTION

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

The present invention, a thin film measurement technique, is comprised of: one or more radioisotopes emitting radiation; one or more radiation detectors which transmit electrical signals to measurement and data acquisition electronics; enabling mechanical hardware, which exchanges samples and/or detectors; electronics and/or circuitry, wires, cables, and connectors; measurement software for quantifying measurements, and process control and optimization; and a computer which collects and transmits data and/or power.

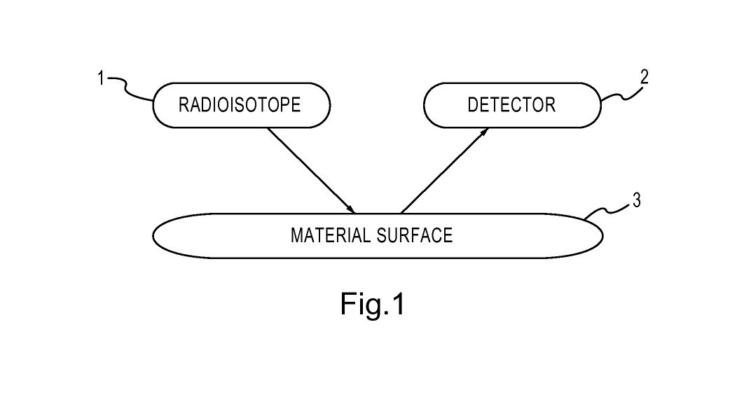

As depicted in FIG. 1, one or more radioisotopes 1 can be configured to emit radiation that impinges on a material surface 3. The radiation interacts with the material surface 3, the resultant radiation emerges from the material surface 3, and one or more detectors 2 detect one or more types of radiation. One embodiment of this invention can be an alpha-particle emitting radioisotope that emits charged particles (i.e. alpha particles) that backscatter (or forward scatter lighter elements) from the material surface into a charged particle detector. The charged particle detector provides electronic signals to the data acquisition system where features and characteristics of the energy spectrum of the backscattering (or forward scattering) charged particles can be correlated to features and characteristics of the material surface.

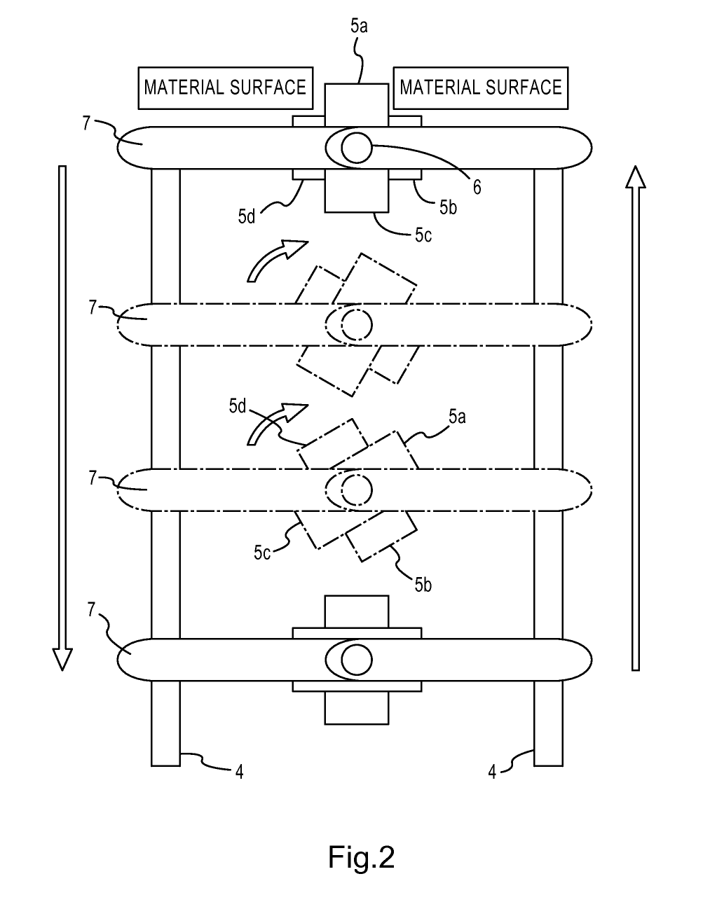

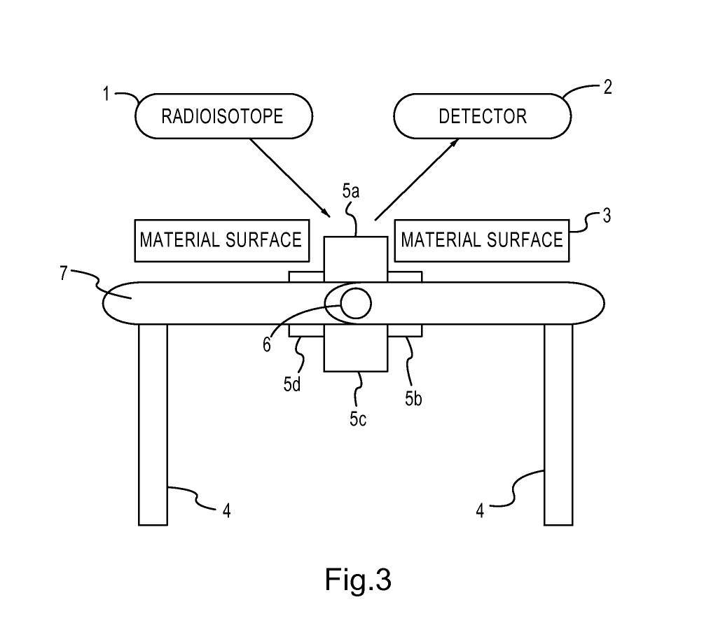

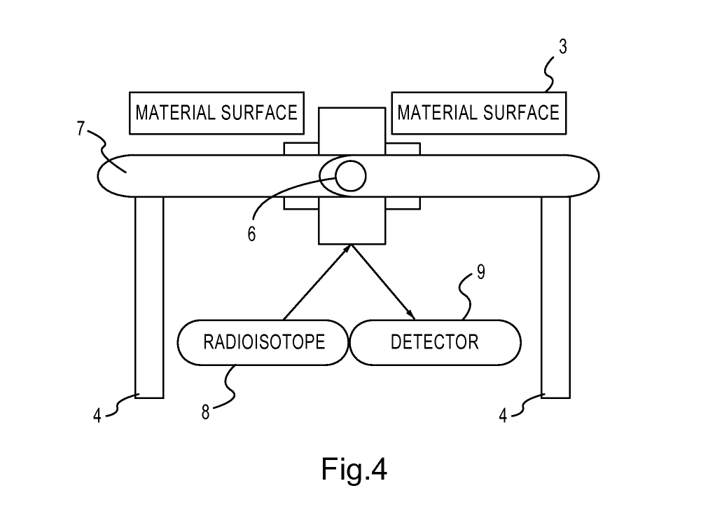

FIG. 2 depicts a mechanical assembly for allowing samples and/or detectors to be alternately positioned for: 1) exposure to manufacturing and other processes and 2) analysis using variations of the basic setup shown in FIG. 1. In this example, an assembly, of four sample surfaces 5a,b,c,d, is mounted by way of a rotational transmission axle 6 on a translating plate 7. The translating plate 7 moves linearly on linear bearings 4, and this linear motion causes the four sample surfaces 5a,b,c,d to rotate through ninety degrees of motion, effectively positioning the subsequent surfaces for 1) exposure to manufacturing processes, such as thin film deposition, and 2) analysis using the radioisotope 1 and detector 2, in a variety of configurations and combinations, such as those shown in FIG. 3 and FIG. 4.

As depicted in FIG. 3, a radioisotope 1 and detector 2 can be positioned above the material surface and mechanical assembly. Alternately, as depicted in FIG. 4, a radioisotope 1 and detector 2 can be positioned behind the material surface 3 within the mechanical assembly. This implementation allows in-situ measurements to be made without interrupting processes occurring at the material surface 3. Additionally, a variety of measurement sensors 12, comprised of one or more different or similar radioisotopes 1, and one or more different or similar detectors 2, can be integrated into the assembly replacing surfaces 5a,b,c,d.

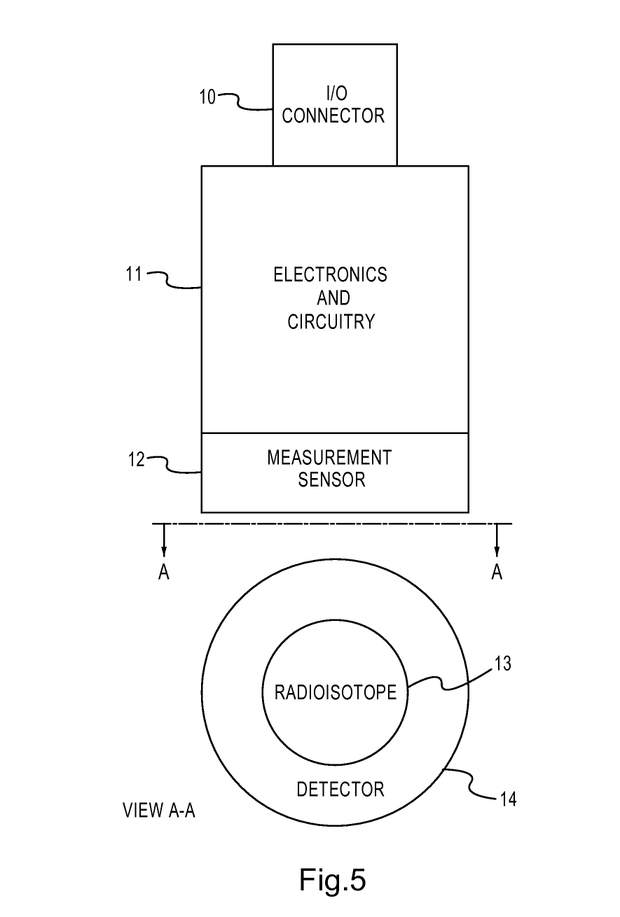

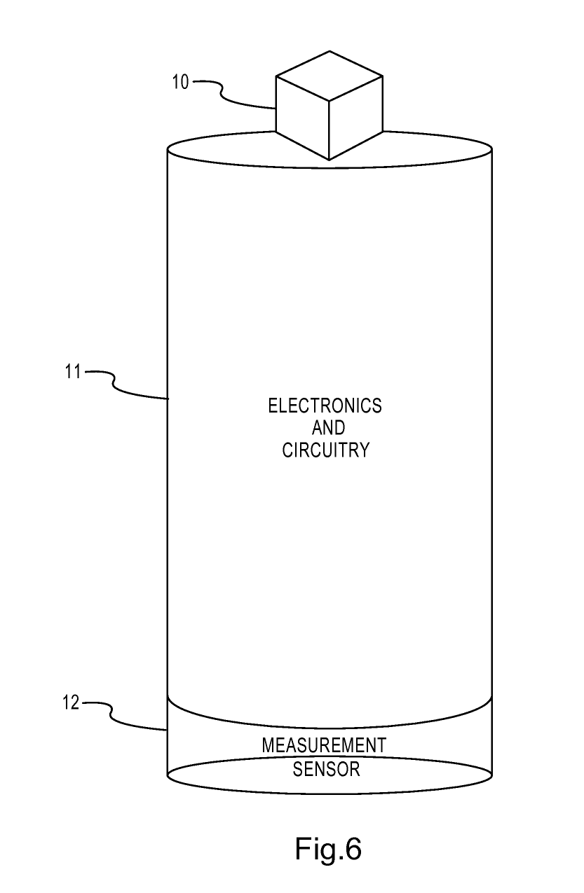

Combining a radioisotope and detector into one assembly creates an integrated measurement sensor 12. Further, by integrating the measurement sensor 12, electronics and circuitry 11, and an input/output connector 10, a single unit measurement device that can be made to plug directly into a computer. FIG. 5 and View A-A show one example of such an integrated measurement sensor that uses an annular detector 14, which surrounds a radioisotope 13. FIG. 6 shows an isometric view of the full measurement device.

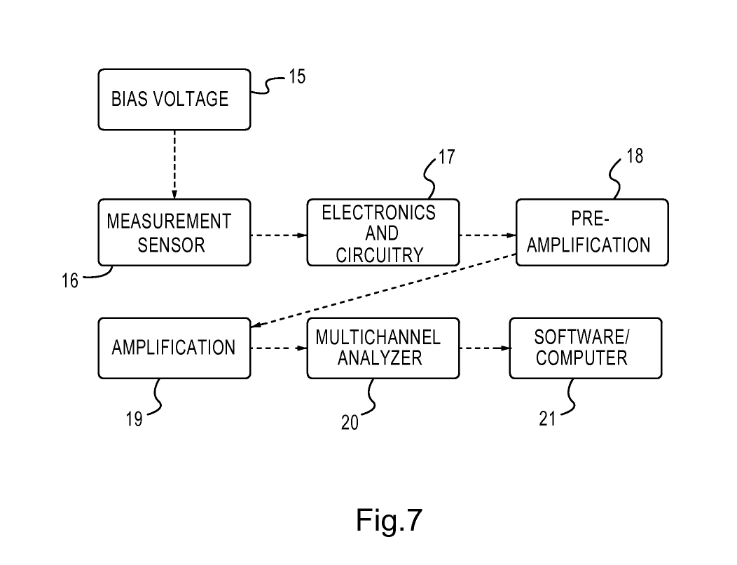

Exampled of basic elements and components of the thin film measurement technique are shown in FIG. 7. A bias voltage 15 is applied to the measurement sensor 16, which produces electrical signals that are transmitted to and through electronics and circuitry to a pre-amplifier 18. From the preamplifier 18, the electrical signal goes to an amplifier 19, and upon further amplification, the electrical signal is transmitted to a multi-channel analyzer 20. The multi-channel analyzer 20 categorizes the electrical signals and passed them to the measurement software and computer 21, from which a user can observe, record, or transmit the measurement; the measurement can also be utilized in a database, transmitted over a network, or directly transmitted to other equipment, systems, or devices.

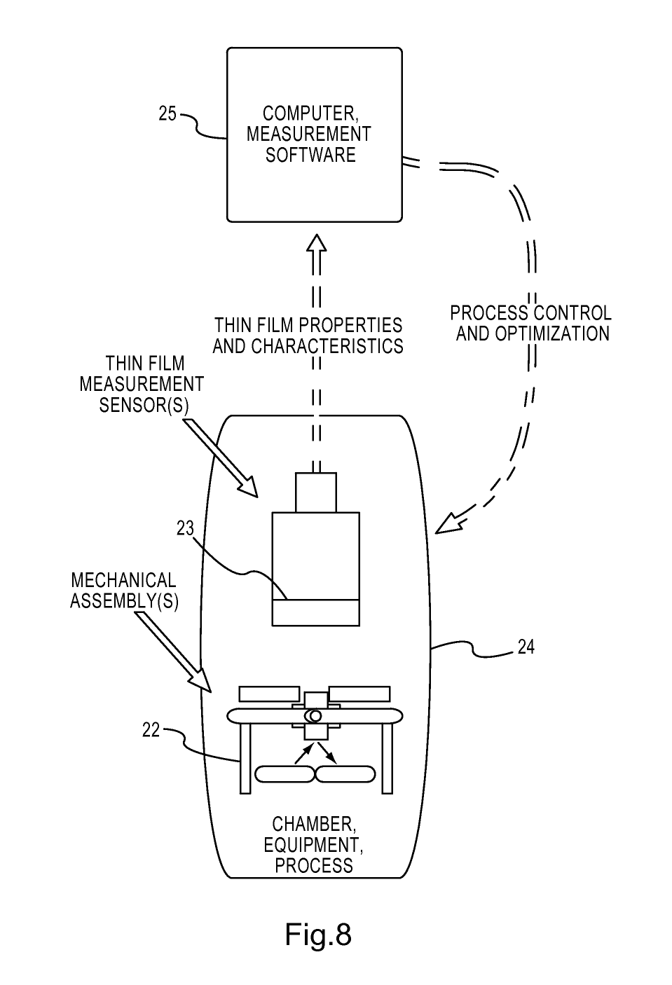

Processes can be controlled and optimized based on the results and output from the thin film measurement technique. FIG. 8 depicts one example of the thin film measurement technique implemented in a chamber, piece of equipment, or process 24. A series of measurement sensors 23 and mechanical assemblies 22 can be integrated into the chamber, equipment, or process 24. The film properties and characteristics are then sent from the measurement sensors 23 to the measurement software 25.

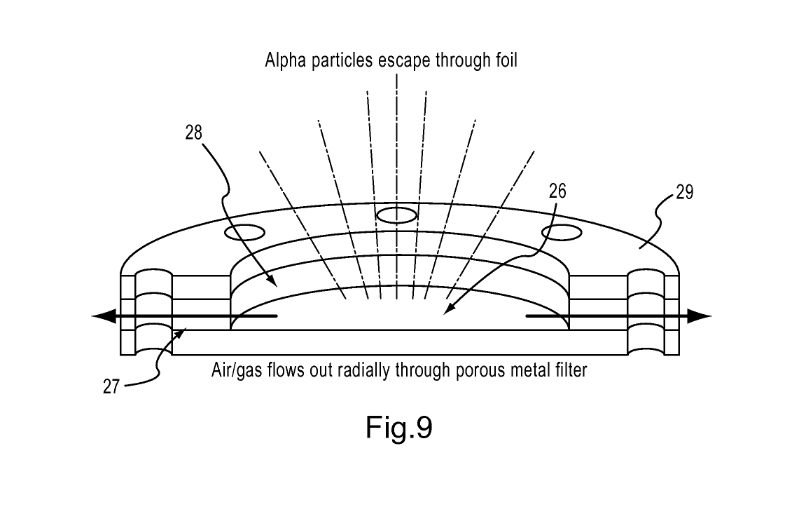

In certain situations, it can be necessary and advantageous to place radioisotopes in a sealed container that allows useful radiation to emerge from the radioisotope, but precludes any of the radioisotope material from transferring to any other surface or surrounding region. One example of a filter housing is shown in FIG. 9. In this example, a radioisotope 26 is contained with a housing, which comprises a thin foil 28, porous metal filter 27, and other assembly material 29. This example of a filter housing is especially well suited for, but not limited to, use of radioisotopes in a vacuum environment.

1. A thin film measurement technique comprising: one or more radioisotopes; one or more radiation detectors; enabling mechanical hardware; electronics and/or circuitry, wires, cables, and connectors; measurement software; and a computer.

2. A mechanical assembly used alone or in combination with other aspects of the thin film measurement technique of claim 1, or other analysis techniques and technologies.

3. A simulation package used alone or in combination with other aspects of the thin film measurement technique of claim 1, or other analysis techniques and technologies.

4. A measurement sensor, comprising one or more radioisotopes and one or more radiation detectors, used alone or in combination with other aspects of the thin film measurement technique of claim 1, or other analysis techniques and technologies.

5. A measurement technique, comprising one or more radioisotopes and one or more radiation detectors, used alone or in combination with other aspects of the measurement technique, or other analysis techniques and technologies.

6. A filter housing used alone or in combination with other aspects of the measurement technique, or other analysis techniques and technologies.

7. A system that comprises any combination of the components of claim 1, alone and/or as part of an integrated diagnostic system, chamber, and/or other processing and/or manufacturing equipment.

8. A system that comprises any combination of the components of claim 1 for use in the solar photovoltaic industry, semiconductor industry, thin-film coating industry, plasma processing industry, medical devices industry, protective coating industry; and in equipment specific to these industries and/or across industries including but not limited to these industries.

9. A vacuum, analysis, processing, and/or manufacturing chamber that utilizes, alone or together, any combination of the components of claim 1, including but not limited to radioisotopes, radiation detectors, measurement sensors, enabling hardware, measurement software, electronics and/or circuitry, and other techniques and technologies.

10. The thin film measurement of claim 1, wherein the radioisotope(s) is(are) an alpha radioisotope.

11. The thin film measurement of claim 1, wherein the radiation detector(s) is(are) a charged-particle detector.

12. The thin film measurement of claim 1, wherein the radiation detector(s) is(are) an X-ray detector.

13. The thin film measurement of claim 1, wherein the radioisotope(s) is(are) an alpha radioisotope.

14. The measurement sensor of claim 4, wherein the radiation detector(s) is(are) a charged-particle detector.

15. The measurement sensor of claim 4, wherein the radiation detector(s) is(are) an X-ray detector.

16. A system or piece of research, industrial, and/or manufacturing equipment compatible with and/or designed for any combination of components of claim 1.

17. The manufacturing, fabrication, and design processes used to reduce to practice any of the aspects of claim 1, alone or in any combination.
